(19) United States
(12) Patent Application Publication
(10) Pub. No.: US 2012/0003960 A1
(43) Pub. Date: Jan. 5, 2012

(54) Mobile device control using a tethered connection

(76) Inventors: Ramesh Parmar, Scotch Plains, NJ (US); Deepak Gonsalves, Union, NJ (US); Deepa Jagannatha, Somerset, NJ (US)

(21) Appl. No.: 13/175,029

(22) Filed: Jul. 1, 2011

Related U.S. Application Data
(60) Provisional application No. 61/360,778, filed on Jul. 1, 2010.

(51) Int. Cl. H04W 12/00

(52) U.S. Cl. 455/411

(57) ABSTRACT

Disclosed is a virtual mobile management tool that allows a remote support technician to access applications and data on a mobile device connected through a desktop computer that in turn is connected to internet. A user can connect the mobile device to a desktop computer, which has internet connectivity, and initiate a trouble ticket. A support admin installs the current invention remotely on the user's desktop and communicates with the mobile device.

### PRIORITY CLAIM

This application is based upon U.S. Provisional Application 61/360,778 entitled Mobile Device control using a Tethered Connection filed Jul. 1, 2010 the contents of which are incorporated herein by reference.

### FIELD OF INVENTION

The present invention relates to mobile wireless communication devices, systems, networks, and methods of operation. This invention describes remote management of the mobile devices connected to a computer. This invention deals with the various modes for the user to request remote support.

### BACKGROUND

Cellular telephone systems and the like continue to meet consumer expectations. While cellular telephone systems were originally created for transmitting voice signals, they have improved into mobile communication devices that are able to communicate data information, provide GPS coordinates, website surfing, database storage, video and pictures, music storage, and so forth. While such improvements have produced incredible technologically advancements telephones, they have also led to complications in troubleshooting. If a telephone is in need of repair, the consumer will need to either figure out how to correct the problem or bring it into a service center. If the telephone is brought in for service, the service center needs a trained individual on site. The inconvenience to the consumer can hurt the reputation of the telephone manufacturer and service provider, even if the problem was caused by the individual.

Thus, what is lacking in the art is a virtual mobile management tool that allows a remote support technician to access applications and data on a mobile device connected through a desktop computer that in turn is connected to internet.

### SUMMARY OF THE INVENTION

The current invention is a mode of virtual mobile management (VMM) tool that allows a remote support technician to access applications and data on a mobile device connected through a desktop computer that in turn is connected to internet. If there is no internet connectivity on the mobile device, troubleshooting is challenging. In this scenario the user can connect the mobile device to a desktop computer which has internet connectivity and initiate a trouble ticket. The support administrator can install the current invention remotely on the user's desktop and communicate with the mobile device.

An objective of the invention is to provide administrative support by allowing connectivity to a mobile device irrespective of the mobile device operating system.

Still another objective of the invention is to provide the ability to observe activity on a user's mobile device that allows support personnel to quickly pinpoint the source of a user's problem and provide proper instructions to the user.

Yet another objective of the invention is to provide the ability to take control of a user's mobile device remotely allows support personnel to quickly assist without having the user to bring the device into a repair facility.

Another objective of the invention is the establishing of a remote session with a mobile device through a desktop computer which is transparent to the end user.

Another objective of the invention is to enhance user experience and effectively reduces customer support duration.

Still another objective of the invention is to allow an operator to validate the mobile device performance during streaming.

Still another benefit of the invention is it will allow support admin to remotely view and control a mobile device even in cases where there is no data connection on the phone.

Another benefit of the invention is it provides the operators with the ability to capture OTA logging during data call setup, call teardown, dormancy in/out, data retry, etc., allows the operator to Modify/Update device configurations, and allows for Inventory collection.

Yet another benefit of the invention is that it permits Backup/Restore function including Files, Contacts, Emails, SMS, Configuration.

Still another benefit of the invention is that it is platform-agnostic of the type of operating system on the mobile device.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 is an illustration of the architecture of the instant invention;

FIG. 2 is the protocol stack;

FIG. 3 is the state transition diagram;

FIG. 4 provides the functional components of the instant invention;

FIG. 5 is the D2mControllerEngine diagram;

FIG. 6 is the D2mController Engine State Machine diagram; and

FIG. 7 is the call flow chart.

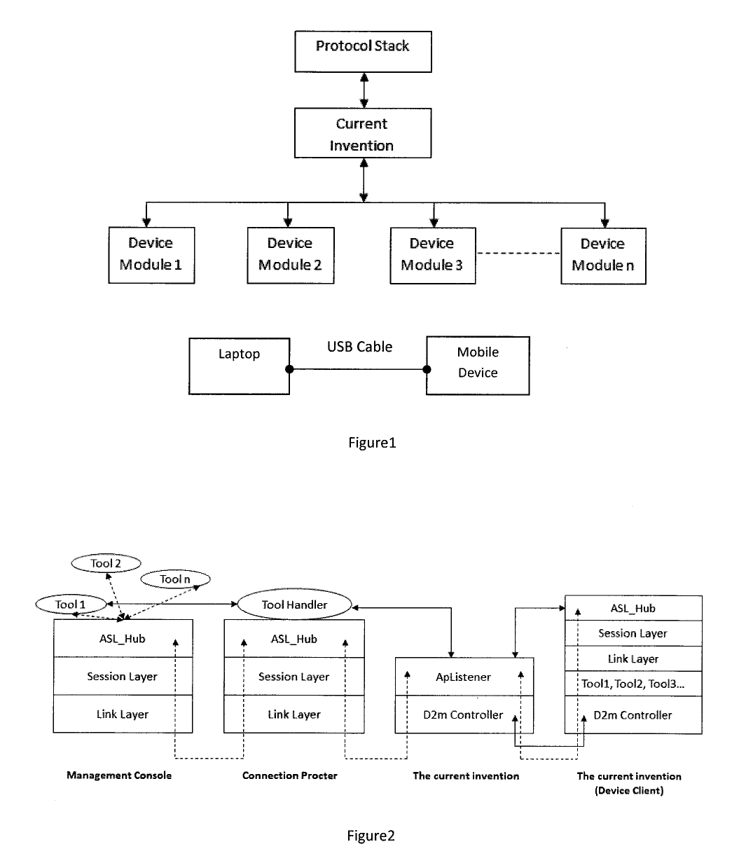

### DETAILED DESCRIPTION OF THE INVENTION

The functionality described in this invention provides access to applications and data on a mobile device connected through a desktop computer. The setup involves an application installed on the desktop computer and one on the device. FIG. 1 is a diagram that describes the setup and the details of the current invention as explained in the next sub section. The main system component includes the following, Connection Proctor, Admin Server, Management Console, and the mobile device control.

The connection proctor server provides the endpoint for the device network connection. The connection proctor authenticates incoming connections for authorized devices. This enables fast resume and reconnect features for devices and applications by supporting load balancing across multiple computers that are running the connection proctor and seamlessly handles all connections to heterogeneous devices with different Operating systems. The connection proctor server comprises two components, a connection monitor that creates a session ID for new connection request and monitors all the scheduled and existing sessions. A connection handler which handles all the sessions load distributed across different connection handlers, each handler handles multiple sessions.

The admin server is the primary administration and management service for all managed devices and servers. This server communicates with existing servers and manages the translation of information and commands between the server and managed devices. The management console provides a graphical user interface for controlling mobile devices, and servers.

The mobile device control allows remote support personnel to connect to any device through the laptop in scenarios where there is no internet connectivity on the phone to remotely view and control the device over the air. Irrespective of the device OS type, the remote support personnel can connect to the mobile device.

A protocol stack has the following layers and component modules, Application Sub Layer Hub (ASL Hub), Session Layer, Link Layer and mobile device control. The ASL Hub Layer is the topmost layer of the protocol stack which acts as a hub in establishing connection with the Service Tools (Virtual Mobile Management) and the Session Layer. It is the single point of entry to the Service Tools and provides a consistent set of interfaces for remote communication. For every Application request an appropriate instance of the session is invoked. The Session Layer is responsible in establishing and maintaining a session for the protocol stack, in response to a remote connection request from the ASL Hub. The Session Layer maintains a state machine, which defines the rules to maintain the lifetime of the session through state transition procedures. The Session Layer is responsible to maintain the signal link with its peer. The Link Layer establishes two types of links for the peers to communicate with each other and send information. A bearer link will be used to send only bearer messages between two communicating peers (processes). A signaling link will be used to send only signaling messages between two communicating peers (processes). Signaling link may be used to carry Bearer Link data (BOS: Bearer over Signaling) if necessary (For example: instant message notification. URL can be sent to the device on signaling link) This will avoid any additional resource usage by sending the data on a bearer link.

Interprocess communication, or Peer-to-Peer Communication takes place by means of exchanging messages with appropriate Signal Codes on the signal link. Inter-Layer communication takes place via commands and messages, which are exchanged between layers in the following ways: Method: Each layer will provide methods which are availed by the upper layer; Event: Lower layers will notify registered upper layers using events; and Callback: Upper layers can register with the lower layers to receive messages through callback.

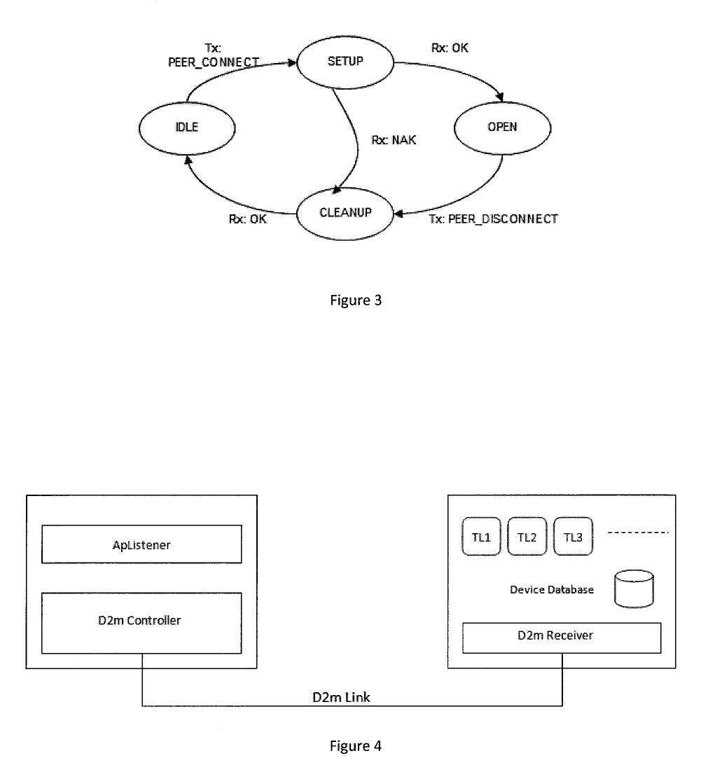

In peer-to-peer connection, every layer manages its own Protocol Stack and Event States. When a connection request is made all the layers in the protocol stack in each peer will have to transition into different states at different events. The below section will describe how this connection is established. FIG. 3 is the State Transition Diagram.

Step 1: When a Connection request is made for any service tool (Virtual Mobile Management), the Management Console sends a PEER_CONNECT request to the Connection Proctor Server.

Step 2: The Connection Proctor server authorizes the Connection Request and sends the PEER_CONNECT request to the relevant device.

Step 3: When the client (APLISTENER) receives the PEER_CONNECT request message it has to send an ACK or NAK based on its current state.

Step 4: Once the Server receives an ACK it will make the appropriate TOOL_SERVICE request with the Client.

Step 5: Based on the response (ACK or NAK) the Connection proctor will establish a peer-to-peer connection or disconnect the session.

For every session established the following pre-check will be done by the Admin Server: Every session shall have a unique Session Handle ID. Every Session Handle shall have session states: InProcurement: When a Connection Request is successful and InSession: When a peer-to-peer connection is established. Every peer will be maintaining its own state: Open, Setup, Cleanup and Idle.

The client and server controller modules of the instant invention are called D2mReceiver and D2mController respectively. The D2mController and D2mReceiver modules communicate through the D2mLink. FIG. 4 provides the functional components of the instant invention.

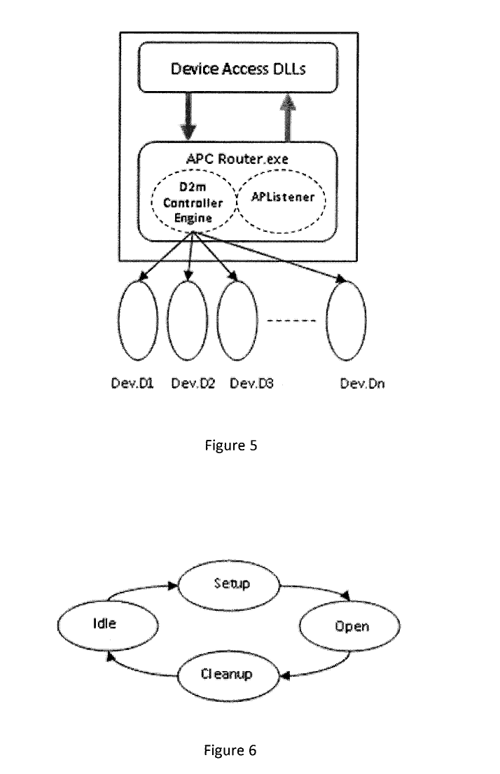

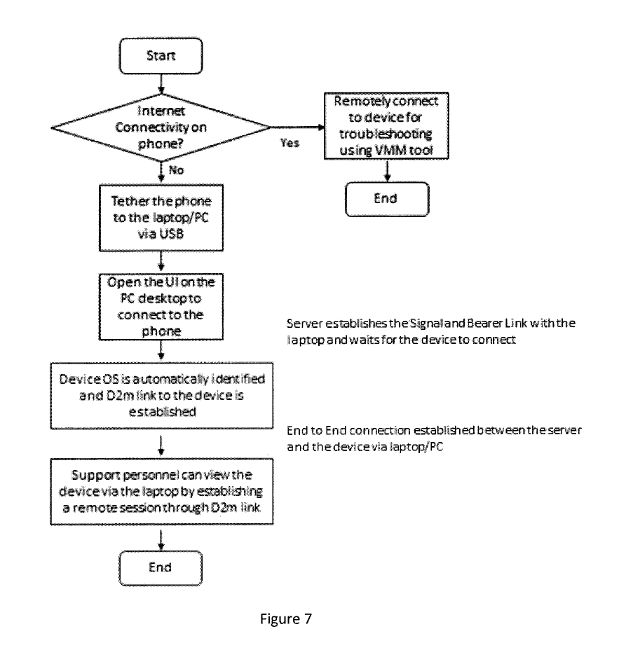

FIG. 5 is the D2mControllerEngine. D2mController framework logically consists of two components: Component C1: Device Access Interface, which will be invoked from a console application or a Graphical User Interface (GUI), based application. Component C2: APCRouter.exe, which loads the device driver during runtime.

The Component C2 consists of D2mController Engine, ApListener and D2mDriverInterface. The D2m Controller Engine maintains its own state machine. Responsible for loading the appropriate device driver via the D2mDriverInterface. Checks the Configuration file for the right device driver for that particular device OS type during runtime. Periodically sends PING messages when the state is OPEN. Engine translates API calls to appropriate D2m Messages to be sent over the D2m Link. FIG. 6 is the D2mController Engine State Machine.

D2mLink: The D2mController and D2mReciever use the D2m Protocol to communicate over connection established between the computer and the device. This link is referred to as the D2mLink.

Device Discovery Process: When any device is connected to the PC/laptop, the D2mController application when invoked will search for the appropriate device driver to communicate with the device. Irrespective of the device OS type the current invention's device driver module will be able to communicate with the device.

USE CASE: Virtual Mobile Management using the instant invention

Short Description: A mobile subscriber has some problem with the internet connectivity on the phone and SMS is also not working on the device. The subscriber calls the remote support personnel to fix the issues on the mobile device. The remote support personnel will try to connect to the device through the current invention and troubleshoot the device.

Call Flow:
1. Subscriber calls the remote support personnel to assist in troubleshooting the device
2. The remote support personnel will create an enrollment record for the device and requests the subscriber to connect the device to the laptop which has internet connectivity
3. The client is pushed to the laptop and connects to the server where the remote support personnel will be controlling and troubleshooting the device
4. Once the client is downloaded and installed the client automatically connects to the Server
5. The remote personnel will be able to establish a remote session through the laptop and troubleshoot the device

### Protocol Functionality

Step 1: Open the current invention on the desktop computer which is installed as an application. The current invention on the desktop will have a button “CONNECT”. When the user clicks the button, the Device Access Interface invokes the APCRouter which inturn invokes the ApListener and calls the D2mControllerEngine APIs.

Step 2: Once the device is connected to the laptop the current invention will retrieve the device information.
ApListener will require the below information from the device before connecting to the tool
   Device Identifier
   Anchor Server URI
ApListener will instruct (API Call) the Engine to get the device info
The Engine will then (translate the API call to D2m Message) communicate with the Receiver on the device over the D2m Link
The Receiver will retrieve the device info from the device database and sends it to the Engine—ApListener

Step 3: Get Session Handle
ApListener will now connect to the Anchor Server to retrieve the Session Handle using the device info

Step 4: Establish Signal Link between Connection Proctor and APL
After ApListener successfully receives the session handle, will now connect to the connection Proctor
Signal Link is established between Connection Proctor and ApListener

Step 5: Connect to the client tool on the device to remotely view the device through the laptop
Connection Proctor sends the Tool_Service_Request (TSR) to the ApListener once the Signal Link is established
   TSR consists of ToolIdentifier and BOS flag
Aplistener buffers the TSR and creates a ToolServiceConnector (TSC) and instructs the Engine to invoke the Tool (ToolIdentifier=VMM Tool, BOS=True)
The Engine shall translate this to a D2m message and sends to the Receiver
The Receiver sends ACK after successfully invoking the tool
   Receiver will communicate with the tools using CCL (Control Command Link)
APL will now establish a Signal Link directly with the VMM Tool
Now the APL will send the buffered TSR to the VMM Tool on the Signal Link with BOS=True
ApListener will buffer the ACK for TSR sent by the VMM Tool

Step 6: Bearer link establishment with CP
The TSC establishes a Bearer Link with Connection Proctor and sends AUTH message
Once successful the ApListener sends the ACK (TSR) to the Connection Proctor on Signal Link

Step 7: The remote support personnel will be able to view the device remotely once the streaming starts.

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of accessing a mobile device from an internet based computer for virtual management thereof, said method comprising the steps of:
installing a client controller module on said mobile phone and a server controller module on said internet based computer;
receiving a support request by a subscriber regarding an issue with said mobile device;
creating of an enrollment record of said subscriber on said internet based computer;
tethering said server module and said client module;
authenticating incoming connections for authorized mobile devices through a connection proctor; and
viewing of said mobile device through said internet based computer;
wherein support personnel can view the mobile device by the internet based computer for purposes of troubleshooting or performing administrative functions thereon.

2. The method of claim 1 wherein said tethered means is further defined as an over air internet connectivity.

3. The method of claim 1 including the step of establishing a remote session through a D2m link.

4. The method of claim 1 wherein said connection proctor server includes a connection monitor that creates a session ID for a new connection request.

5. The method of claim 1 wherein said step of authenticating incoming connections for
authorized mobile devices through a connection proctor further comprises the step of
sending a PEER_CONNECT request to a Connection Proctor Server;
authorizing said Connection Request and sending the PEER_CONNECT request to a relevant device;
sending an ACK or NAK when a client receives the PEER_CONNECT request message based on its current state, upon receipt of an ACK the Server will make the appropriate TOOL_SERVICE request with the Client; and
establishing a peer-to-peer connection based upon the response (ACK or NAK).

6. The method of claim 1 wherein said connection proctor server includes a connection handler to handle session loads distributed across different connection handlers.

7. The method of claim 6 wherein said connection proctor server monitors scheduled and existing sessions.

8. The method of claim 1 wherein said server controller module comprises a device access interface invoked from a console based application.

9. The method of claim 1 wherein said server controller module comprises a device access interface invoked from a Graphical User Interface based application.
